(19) United States
(12) Patent Application Publication
(10) Pub. No.: US 2008/0055948 A1
(43) Pub. Date: Mar. 6, 2008

(54) Ripple-free drive circuit for LED backlights of LCD panel

(75) Inventors: Tsai-Fu Wu, Chia-Yi (TW); Chang-Yu Wu, Chia-Yi (TW); Chien-Chih Chen, Tai-Nan County (TW); Po-Chang Lu, Chia-Yi (TW)

Correspondence Address: BACON & THOMAS, PLLC, 625 SLATERS LANE, FOURTH FLOOR, ALEXANDRIA, VA, 22314, US

(73) Assignee: NATIONAL CHUNG CHENG UNIVERSITY, CHIA-YI (TW)

(21) Appl. No.: 11/708,474

(22) Filed: Feb. 21, 2007

(30) Foreign Application Priority Data
Aug. 30, 2006 (TW) 95132068

(51) Int. Cl. H02M 7/04

(52) U.S. Cl. 363/84

(57) ABSTRACT

A ripple-free drive circuit for LED backlights of an LCD panel includes a PFC circuit, a DC/DC converter, three output load units, and a drive voltage resetter. The PFC circuit is connected with the mains power for outputting DC power. The DC/DC converter is connected with the PFC circuit. The three output load units are connected with the DC/DC converter for outputting red, green, and blue lights respectively, each having an electrically-controlled switch. The drive voltage resetter is connected with the DC/DC converter and the three output load units for preventing the three output load units from generation of surge current in a moment of electric conduction. In light of this, the ripple-free drive circuit is qualified as the drive power source of the LED backlights and can effectively isolate the surge current to prevent the surge current from entry into the output load units.

### BACKGROUND OF THE INVENTION

1. Field of the Invention

The present invention relates generally to electronic circuits, and more particularly, to a ripple-free drive circuit for LED backlights of an LCD panel.

2. Description of the Related Art

The currently available liquid crystal display (LCD) is not self-luminous and has to employ the light source provided by the backlight module for display. The generally popular light source of the backlight module is based on the cold cathode fluorescent lamp. However, the cold cathode fluorescent lamp has the following drawbacks:

1. It is hydrargyrate to cause environmental pollution.

2. It needs a high-voltage lighter.

3. It has shorter longevity.

4. It is limited in the range of color applications.

In light of the above, employing light emitting diodes (LEDs) free from the above-mentioned drawbacks for the light source of the backlight lamp of the LCD has become the future developing tendency.

Referring to FIG. 7 illustrating a schematic structure of a conventional LCD, a backlight source 200 includes a white backlight 201 and a light guide 202. A crystal liquid panel 100 includes two polarized plates 101 and 102, a common electrode 110, pixel electrodes 111R, 111G, and 111B, film transistors 112R, 112G, and 112B, red, green, and blue filters 113R, 113G, and 113B, and liquid crystal molecules 114. A pixel is formed of one of the red filters 113R, one of the green filters 113G, and one of the blue filters 113B. All of the filters of the three different colors are placed on the common electrode 110. The conversion of electric filed between two electrodes corresponding to each of the filters of respective colors can change the intensity that the light runs through the filters. Further, the light mixture of red, green, blue colors enables one single pixel to generate diverse color variations.

Because the white backlight 201 is white light source, the conventional LCD has to employ the color filters to display the colors. Further, the light utilization efficiency of the color filters is only 37% to further cause many drawbacks of the conventional LCD, such as low light utilization efficiency, uneasily enhanced resolution, and low overall efficiency. If the light source is provided with red, green, and blue colors and the alternative display technology is applied to exclude the color filters from the LCD, the light utilization efficiency and the overall efficiency of the LCD will be dramatically enhanced and the limitation of the resolution can be eliminated.

Referring to FIG. 8 illustrating the structure of a conventional LCD having no color filters, the LCD panel 100′ is structurally similar to the above-mentioned LCD panel 100 shown in FIG. 7 but different in having none of any color filters. The backlight module 200′ includes red, green, and blue backlights 201R′, 201G′, and 201B′, and a light guide 202′. The red, green, and blue backlights 201R′, 201G′, and 201B′ do not illuminate at the same time but in time sequence. Such illumination based on rapid changeover and additive color mixture of the three independent color lights to have random color lights is called color sequential method. To prevent the naked eyes of a user from awareness, each interval between the illuminations of the light source has to be short, and thus the selected light source has to be switched rapidly in a short time. In comparison with the cold cathode fluorescent lamp, the respondence of the LED is quicker to be more suitably acted as the light source that the color sequential method is applied.

Since the three light sources illuminate one by one, during the period of each illumination, the film transistor 112′ has to control each pixel for the brightness of the pixel, and then the pixel becomes a color pixel after the rapid changeover among the red, green, and blue lights. Thus, the LED array and the film transistor 112′ must be operated synchronically to ensure the LCD panel to display the color correctly. However, the changeover speed of the liquid crystal molecules 114′ is the primary bottleneck of development of the color sequential method. Because the light source is sequential illumination of the red LED array 201R′, green LED array 201G′, and blue LED array 201B′, in a moment of the changeover of each LED array, the liquid crystal molecules 114′ also have to change the rotational angle. However, the prior art fails to control such rapid changeover of the liquid crystal molecules 114′.

In addition, if the illumination of the backlight module is based on the color sequential method, because the color filters are not required, it will have advantages of power saving, high resolution, and low cost. However, the chroma of the LED will deviate as the current changes, as shown in FIG. 9. To reach the required performance of the LCD, the chroma variation Δuv must be smaller than 0.002, and thus the ripple of output current must be decreased to the minimal while designing the driver of the LED arrays.

### SUMMARY OF THE INVENTION

The primary objective of the present invention is to provide a ripple-free drive circuit for LED backlights of LED panel, which can supply power for different loads in sequence without output of ripple current to be qualified as a drive power of the LED backlights.

The foregoing objective of the present invention is attained by the ripple-free drive circuit composed of a power factor correction (PFC) circuit, a direct current to direct current (DC/DC) converter, three output load units, and a drive voltage resetter. The PFC circuit is connected with the mains power for rectification and power regulation of the current from the mains power and then outputting DC power. The DC/DC converter is connected with the PFC circuit for converting voltage of the DC power. The three output load units are connected with the DC/DC converter for outputting red, green, and blue lights respectively, each having an electrically-controlled switch for being controlled to switch ON/OFF the corresponding output load unit. The drive voltage resetter is connected with the DC/DC converter and the three output load units for preventing the three output load units from generation of surge current in a moment of electric conduction. In light of this, the power can be supplied for the output load units in sequence and no ripple current will be outputted, such that the present invention can be taken for the drive power source of the LED backlight. In addition, the present invention can effectively isolate the surge current to prevent the surge current from entry into the output load units.

### BRIEF DESCRIPTION OF THE DRAWINGS

FIG. 1 is a block diagram of a preferred embodiment of the present invention.

FIG. 2 is a circuit diagram of a part of the preferred embodiment of the present invention, illustrating the circuit architecture of the DC/DC converter, the output load units, and the drive voltage resetter.

FIG. 3 is a circuit diagram of a part of the preferred embodiment of the present invention, illustrating the circuit architecture of the drive voltage resetter.

FIG. 4 is a circuit diagram of the preferred embodiment of the present invention, illustrating a circuitry that the inductive value is referentially based.

FIG. 5 is an oscillogram of the preferred embodiment of the present invention.

FIG. 6 is a circuit diagram of a part of the preferred embodiment of the present invention, illustrating several circuitries of the DC/DC converter.

FIG. 7 is a schematic structural view of a conventional LCD.

FIG. 8 is a schematic structural view of a conventional LCD having none of any color filters.

FIG. 9 is a chart illustrating the relationship between the chroma and the current of a conventional LED.

### DETAILED DESCRIPTION OF PREFERRED EMBODIMENTS

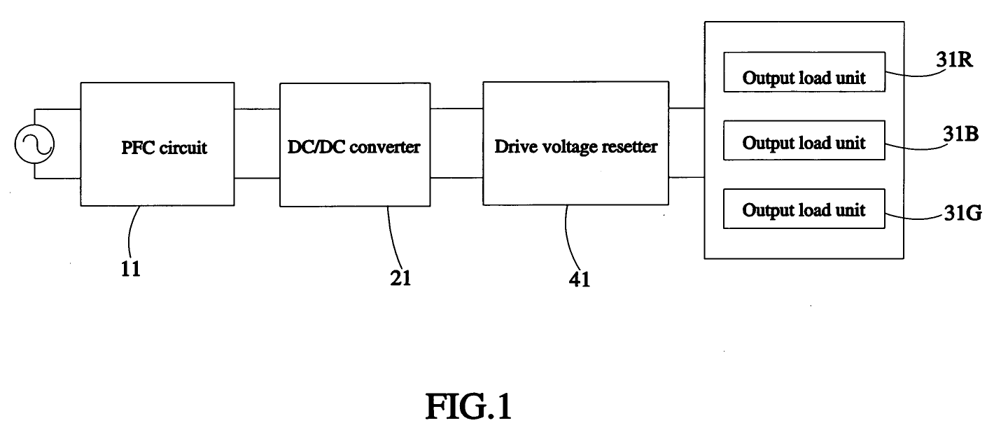

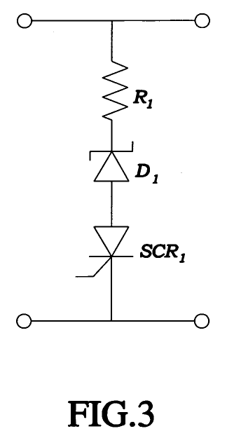

Referring to FIGS. 1-3, a ripple-free drive circuit 10 for LED backlights for an LCD, constructed according to a preferred embodiment of the present invention, is composed of a PFC circuit 11, a DC/DC converter 21, three output load units 31R, 31G, and 31B, and a drive voltage resetter 41.

The PFC circuit 11 is connected with the mains power for rectification and power regulation of the current coming from the mains power and then outputting DC power. Since the PFC circuit 11 is known as the prior art, no detailed description is necessary.

The DC/DC converter 21 is connected with the PFC circuit 11 for converting the voltage of the rectified DC power by the PFC circuit 11, having a transformer 22 and an inductor L1 connected with a primary side of said transformer 22. The DC/DC converter 21 includes at least one quick switch S1, which is a metal oxide semiconductor field effect transistor (MOSFET) in this embodiment, for rapid changeover for control of the current. The DC/DC converter 21 also includes an output capacitor C_{O} for storage and output of electric energy.

The three output load units 31R, 31G, and 31B are connected in parallel with the DC/DC converter 21. The output load unit 31R includes an electrically-controlled switch S_{R} and a plurality of red LED LED_{R} connected in series. The output load unit 31G includes an electrically-controlled switch S_{G} and a plurality of red LED LED_{G} connected in series. The output load unit 31B includes an electrically-controlled switch S_{B} and a plurality of red LED LED_{B} connected in series. The electrically-controlled switches S_{R}, S_{G}, and S_{B} are connected with the corresponding LEDs LED_{R}, LED_{G}, and LED_{B} respectively and can be controlled to switch ON/OFF illumination of the corresponding LED_{R}, LED_{G}, and LED_{B}.

The drive voltage resetter 41 is composed of a silicon-controlled rectifier SCR1, a Zener diode D1, and a resistor R1, which are interconnected in series. The drive voltage resetter 41 is connected with the DC/DC converter 21 and the three output load units 31R, 31G, and 31B for preventing the three output load units 31R, 31G, and 31B from surge current generated in a moment of the electric conduction.

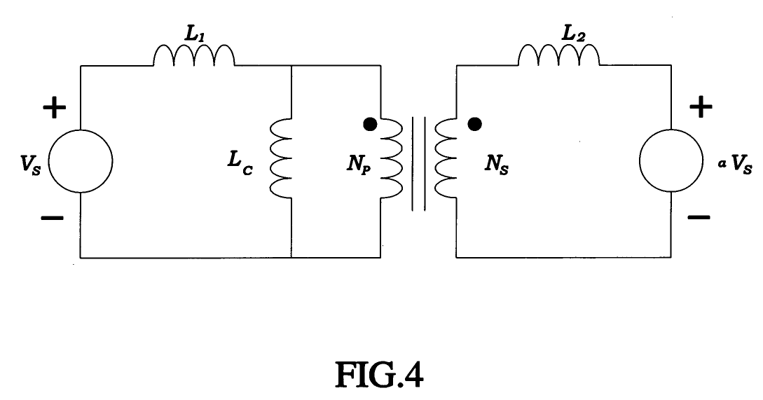

FIG. 4 illustrates the design principle that the inductive vale of the inductor L1 is based. In FIG. 4, an inductor L_{C} is connected with the primary side of the transformer 22 in parallel and the inductor L2 is connected with a secondary side of the transformer 22. If the inductive value of the inductor L1 is designed as

$${L}_{1} = {L}_{c} ( \frac{{N}_{s}}{{aN}_{p}} - 1 ) ,$$

the secondary side of the transformer 22 will not generate the ripple current and thus the ripple current can be avoided.

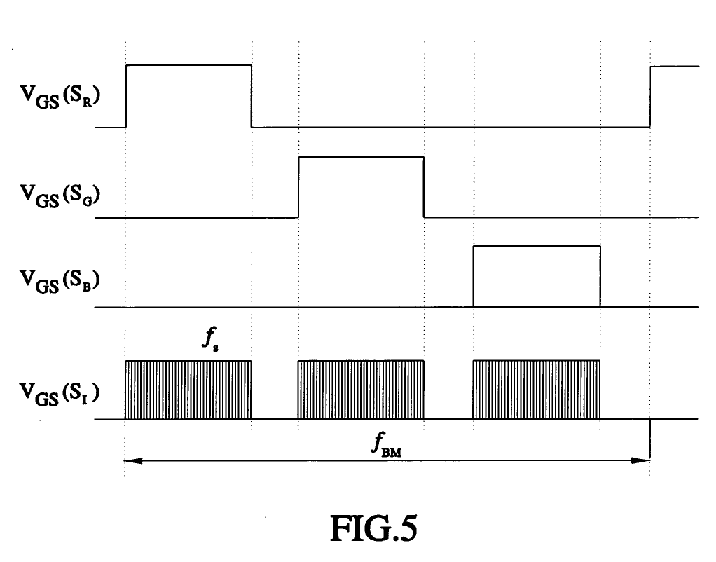

FIG. 5 illustrates drive signals of the quick switch S1 and the electrically-controlled switches S_{R}, S_{G}, and S_{B}. In FIG. 5, V_{GS} (S1) indicates the quick switch S1 and f_{S} indicates the changeover frequency of the quick switch S1; f_{BM} indicating the changeover frequency of the electrically-controlled switches S_{R}, S_{G}, and S_{B} is usually 60 Hz, in synchronization with the currently commercially available LCD.

In operation, because the three output load units 31R, 31G, and 31B are connected in parallel with the DC/DC converter 21, the output current of the DC/DC converter 21 is directly provided for three output load units 31R, 31G, and 31B, controlling closed/open circuit of the electrically-controlled switches S_{R}, S_{G}, and S_{B} in sequence can switch ON/OFF illumination of the LEDs LED_{R}, LED_{G}, and LED_{B} in sequence. Further, the drive voltage resetter 41 is adapted for isolating the surge current generated in a moment of electrically conducting the output load units 31R, 31G, and 31B. When the surge current is generated, the silicon-controlled rectifier SCR1 can be electrically conducted, and meanwhile, the outputted electric energy of the output capacitor C_{O} is gradually consumed by the resistor R1 and the current flowing through the drive voltage resetter 41 also gradually drops; the output voltage is contained in the breakdown voltage of the Zener diode D1, and then the electrically-controlled switches S_{R}, S_{G}, and S_{B} are electrically conducted, thus securely isolating the surge current from entry into the output load units 31R, 31G, and 31 B.

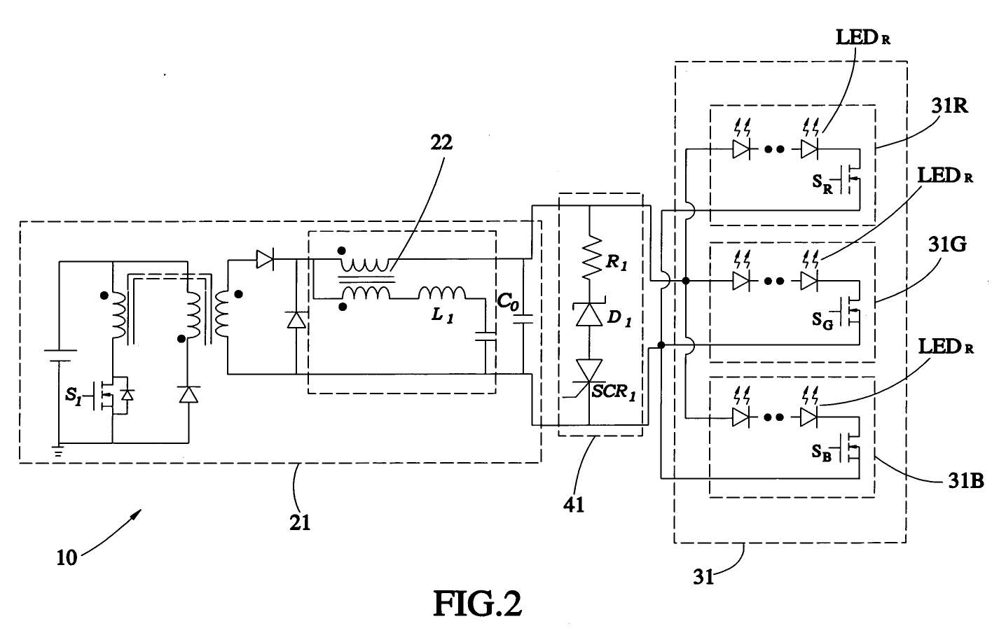

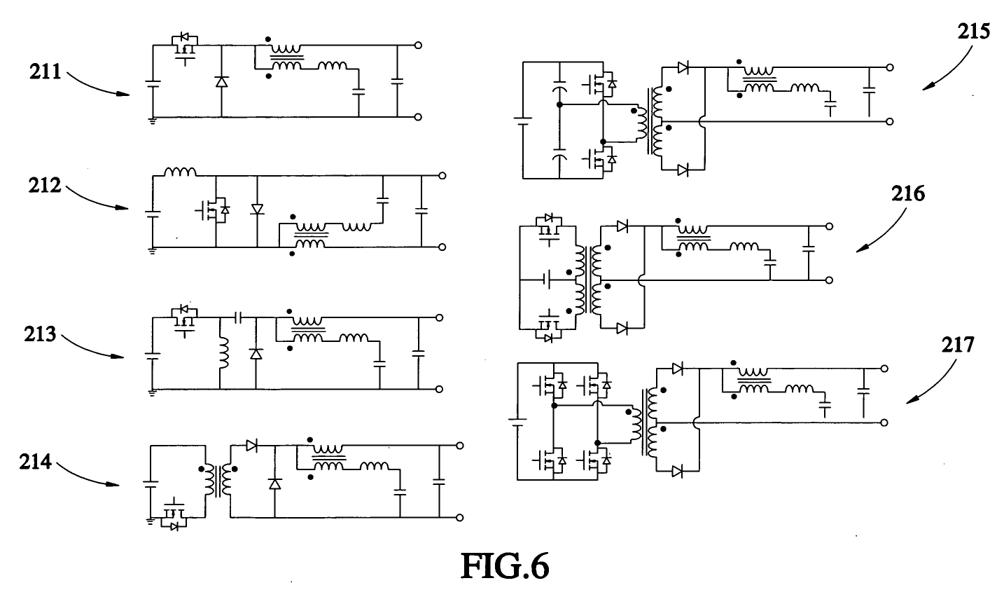

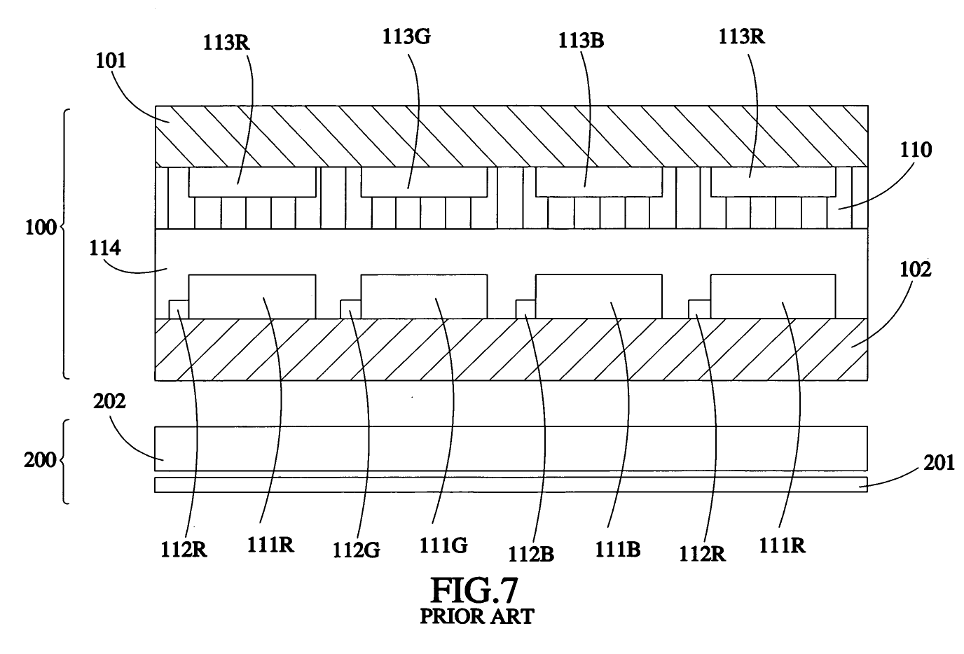

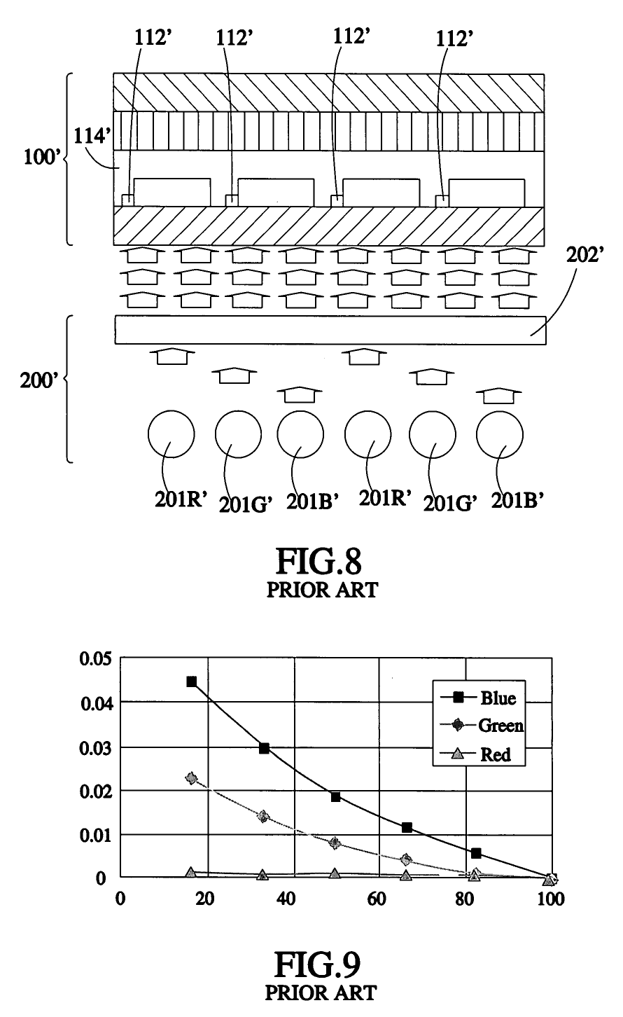

In addition, the DC/DC converter 21 of the present invention is not limited to one type. FIG. 6 shows a ripple-free buck DC/DC converter 211, a ripple-free cuk DC/DC converter 212, a ripple-free zeta DC/DC converter 213, a ripple-free forward DC/DC converter 214, a ripple-free push-pull DC/DC converter 215, a ripple-free half-bridge DC/DC converter 216, and a ripple-free full-bridge DC/DC converter 217, all of which can be applied to the DC/DC converter 21 show in FIG. 2.

In conclusion, the present invention includes the following advantages/effects.

1. The present invention supplies power for each of the output load units in sequence without output of ripple current to further be qualified as the drive power of the LED back light.

2. The present invention can effectively isolate the surge current to prevent the surge current from entry into the output load units.

Although the present invention has been described with respect to a specific preferred embodiment thereof, it is no way limited to the details of the illustrated structures but changes and modifications may be made within the scope of the appended claims.

What is claimed is:

1. A ripple-free drive circuit for light emitting diode (LED) backlights of a liquid crystal display (LCD) panel, comprising:
a power factor correction (PFC) circuit connected with the mains power for rectification and power regulation of current coming from the mains power and then outputting direct current (DC) power;
a DC/DC converter connected with said PFC circuit for conversion of voltage of the DC power;
three output load units connected with said DC/DC converter for output of red, green, and blue lights, each of said output load units having an electrically-controlled switch for being controlled to switch ON/OFF the corresponding output load units; and
a drive voltage resetter connected with said DC/DC converter and said three output load units for preventing said three output load units from generation of surge current in a moment of electric conduction.

2. The ripple-free drive circuit as defined in claim 1, wherein each of said output load units comprise a plurality of LEDs connected in series with said electrically-controlled switches.

3. The ripple-free drive circuit as defined in claim 1, wherein each of said DC/DC converters comprises a transformer and at least one inductor connected with a primary side of said transformer.

4. The ripple-free drive circuit as defined in claim 1, wherein said drive voltage resetter comprises a silicon-controlled rectifier, a Zener diode, and a resistor.

5. The ripple-free drive circuit as defined in claim 1, wherein said DC/DC converter comprises at least one quick switch and an output capacitor, said at least one quick switch being provided for rapidly switching for control of current, said output capacitor being provided for storage and output of electric energy.
